(19) United States
(12) Patent Application Publication
(10) Pub. No.: US 2021/0267371 A1
(43) Pub. Date: Sep. 2, 2021

(54) GUIDE SYSTEMS TO IMPEDE ROTATION OF PANELS

(71) Applicant: Hewlett-Packard Development Company, L.P., Spring, TX (US)

(72) Inventors: Alan Williamson, Boise, ID (US); Clinton Troy Jensen, Boise, ID (US); Lanny J. Hottel, Boise, ID (US)

(73) Assignee: Hewlett-Packard Development Company, L.P., Spring, TX (US)

(21) Appl. No.: 17/256,426

(22) PCT Filed: Oct. 16, 2018
(86) PCT No.: PCT/US2018/056110

§ 371 Date: Dec. 28, 2020

(51) Int. Cl. A47B 88/497

(52) U.S. Cl. CPC A47B 88/497; A47B 2210/0056; A47B 2210/0002

(57) ABSTRACT

According to examples, an apparatus may include a guide system including a first gear having teeth to engage with a first set of teeth, a second gear having teeth to engage with a second set of teeth, the first gear and the second gear to rotate in concert with respect to each other, and a first glide mechanism to slidably contact a first channel. In addition, the apparatus may include a panel to employ the guide system to be slidably mounted to a base structure, wherein the first gear and the second gear are to impede rotation of the panel about a first axis and the first glide mechanism is to impede rotation of the panel about a second axis.

### BACKGROUND

Drawer guide systems may include gravity based systems, simple side guide systems, and extendable side rail systems. In gravity based systems, the bottom of the drawer may sit on a bottom surface of an enclosure, either with or without center guides to control motion of the drawer. In simple side guide systems, the drawer may slide in side rails attached to an enclosure, in which the rails may provide both horizontal and vertical positioning of the drawer. In extendable side rail systems, the drawer may ride on metal rails that slide out when the drawer is opened and the drawer and rails may ride on bushings or bearings.

### BRIEF DESCRIPTION OF THE DRAWINGS

Features of the present disclosure are illustrated by way of example and not limited in the following figure(s), in which like numerals indicate like elements, in which:

FIGS. 1A and 1B, respectively, show block diagrams of example apparatuses that may include an example guide system that may impede rotation of a panel about a first axis and a second axis with respect to a base structure;

FIG. 2 shows a bottom perspective view of the apparatus including the panel and the example guide system depicted in FIG. 1B;

FIG. 3 shows a perspective top view of an example base structure to which the example guide system may be inserted and may engage;

FIGS. 4A and 4B, respectively, show side views of the example apparatus depicted in FIGS. 1A-2 and a cross-sectional side view of the base structure depicted in FIG. 3;

FIGS. 4C and 4D, respectively, show enlarged side views of example first glide mechanisms;

FIG. 5 shows a perspective view of an example glide mechanism that may have a different configuration from the first glide mechanism depicted in FIGS. 4A-4C;

FIG. 6 depicts a perspective view, partially in cross section, of an example first gear and an example second gear that may include a dampening mechanism; and

FIGS. 7A-7D, respectively, show example gear arrangements that may be employed in the guide systems in place of the gears and the racks depicted in FIGS. 1A-2.

### DETAILED DESCRIPTION

Disclosed herein are apparatuses and systems that may include guide systems. The guide systems may be attached to a panel and may include a first gear having teeth that are to engage with a first set of teeth and a second gear having teeth that are to engage with a second set of teeth. The first and second sets of teeth may be provided on separate racks or on opposite sides of a common rack. In addition, the first gear and the second gear may be rotated in concert with respect to each other via a direct contact with each other or via a connecting mechanism, e.g., intermediate gears, a belt, a drive shaft, or the like. As a result, for instance, the first gear and the second gear may rotate in concert through meshing interaction with the first set of teeth and the second set of teeth as the panel is moved.

According to examples, the meshing interaction of the first gear and the second gear with the respective sets of teeth may prevent yaw of the panel (e.g., rotational movement about a vertically extending pivot axis) as the panel is moved. That is, for instance, the first gear and the second gear meshed with the sets of teeth may, in addition to controlling left/right positioning of the panel, the meshed gears and the teeth may resist yaw of the panel.

The guide systems may also include a first guide mechanism, and in some examples, a second guide mechanism. Each of the guide mechanisms may be in gliding contact with a wall of a channel in a base structure. The guide mechanisms may also include pads on upper surfaces of the guide mechanisms to contact ceilings of respective channels when a certain amount of torqueing force is applied onto the panel. As a result, the guide mechanisms may enable a limited amount of vertical rotational movement of the panel when the torqueing force is applied onto the panel.

In some examples, the guide systems may be attached to the panel and the sets of teeth and the channels may be attached to a base structure against which the panel is to be moved, for instance, between retracted and extended positions. In other examples, the guide systems may be attached to a base structure and the sets of teeth and the channels may be attached to the panel. In yet other examples, some of the components of the guide systems may be attached to the panel while other components of the guide systems may be attached to the base structure. Similarly, one of the sets of teeth or the channels may be attached to the panel and the other one of the sets of teeth or the channels may be attached to the base structure. As used herein, the term “attached” may also include integrated with. As such, the description of a glide mechanism being attached to the panel may also include the glide mechanism being integrally formed with the panel. As another example, the description of a channel being attached to the base structure may also include the channel being integrally formed with the base structure.

Through implementation of the apparatuses and systems disclosed herein, rotational movement of a panel may be impeded both during and after extension of the panel with respect to a base structure. In addition, the rotational movement may be impeded through use of relatively simple and inexpensive components. In one regard, by impeding the rotational movement of the panel, the panel may smoothly move between retracted and extended positions.

Before continuing, it is noted that as used herein, the terms “includes” and “including” mean, but is not limited to, “includes” or “including” and “includes at least” or “including at least.” The term “based on” means “based on” and “based at least in part on.”

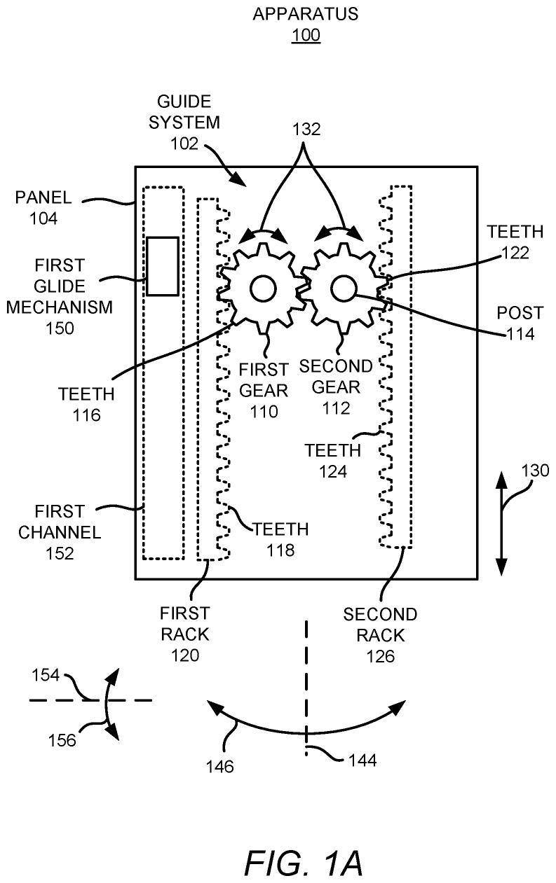

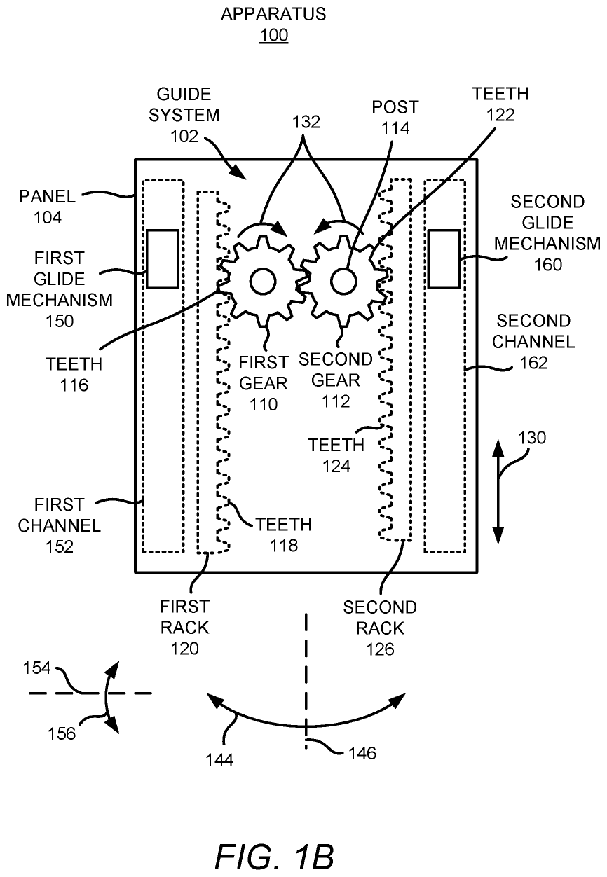

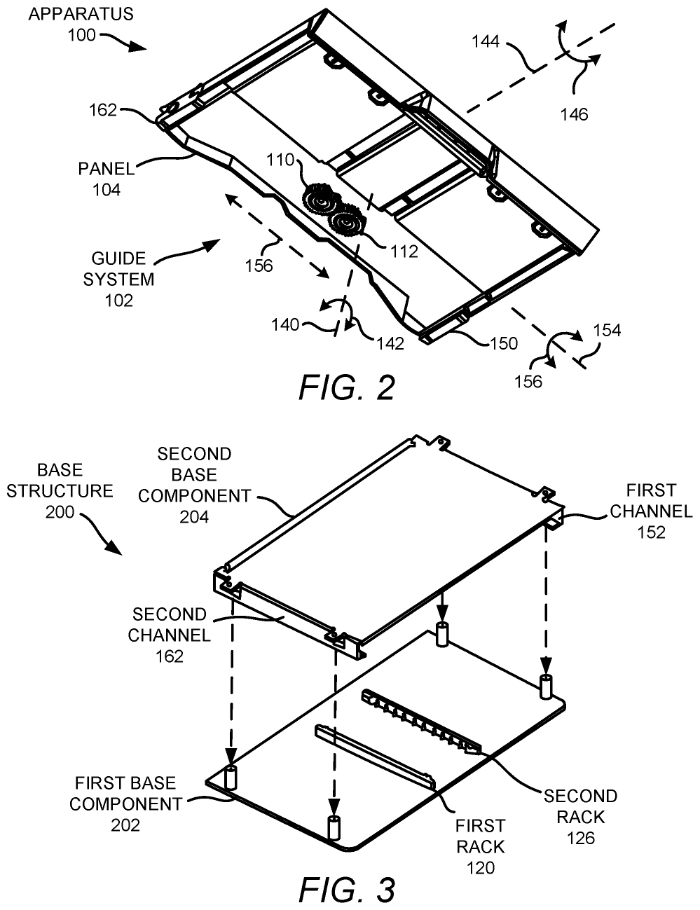

Reference is first made to FIGS. 1A-3. FIGS. 1A and 1B, respectively, show block diagrams of example apparatuses 100 that may include an example guide system 102 that may impede rotation of a panel 104 about a first axis and a second axis with respect to a base structure. FIG. 2 shows a bottom perspective view of the apparatus 100 including the panel 104 and the example guide system 102 depicted in FIG. 1B. FIG. 3 shows a perspective top view of an example base structure 200 to which the example guide system 102 may be inserted and may engage. It should be understood that the apparatus 100 depicted in FIGS. 1A-2 and/or the base structure 200 depicted in FIG. 3 may include additional components and that some of the components described herein may be removed and/or modified without departing from the scopes of the apparatus 100 and/or the base structure 200 disclosed herein.

The apparatus 100 may be a drawer system, a keyboard tray system, a paper tray system, or other type of apparatus that may include a movable panel 104. Particularly, the panel 104 in the apparatus 100 may be movable while minimizing rotational movement of the panel 104 while in an extended position and/or while the panel 104 is moved from a first position (e.g., a storage position) to a second position (e.g., an extended position). The guide system 102 may be formed of any suitable material or materials including plastic, metal, alloys, and/or the like. In addition, the panel 104 may be formed of any suitable material or materials including plastic, metal, alloys, wood, and/or the like.

As shown in FIGS. 1A-2, the guide system 102 may include a first gear 110 and a second gear 112 that may rotatably be attached to the panel 104. For instance, posts 114 may extend from the panel 104 and the first gear 110 and the second gear 112 may rotatably be attached to respective posts 114. As such, the first gear 110 and the second gear 112 may rotate with respect to the panel 104 and to each other. In addition, the first gear 110 and the second gear 112 may remain laterally fixed with respect to the panel 104 as the first gear 110 and the second gear 112 rotate.

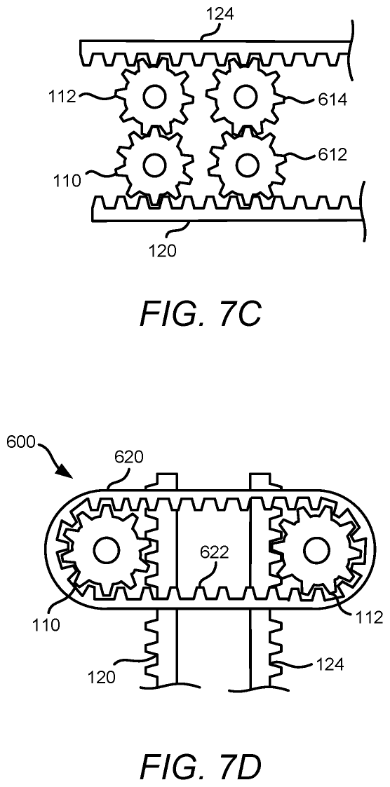

The first gear 110 may have teeth 116 to engage with a first set of teeth 118, which may be provided on a first rack 120. The second gear 112 may have teeth 122 to engage with a second set of teeth 124, which may be provided on a second rack 126. In other examples, the first set of teeth 118 and the second set of teeth 122 may be provided on a common rack (e.g., as shown in FIG. 7B). The first rack 120 and the second rack 126 (or the common rack) may be attached to the base structure 200 such that the panel 104 may be moved as denoted by the arrow 130 with respect to the first rack 120 and the second rack 126. As the panel 104 is moved as denoted by the arrow 130 with respect to the first rack 120 and the second rack 126, the first gear 110 and the second gear 112 may rotate as denoted by the arrows 132.

According to examples, the engagement of the teeth 116 of the first gear 110 with the teeth 118 of the first rack 120 and the teeth 122 of the second gear 112 with the teeth 124 of the second rack 126 may impede rotation of the panel 104 about a first axis 140 (FIG. 2). That is, rotation of the panel 104 may be impeded in the directions denoted by the arrow 142, e.g., the yaw of the panel 104.

The guide system 102 may also include a first glide mechanism 150. The first glide mechanism 150 may be fixedly attached to the panel 104 such that the first glide mechanism 150 may move with movement of the panel 104. The first glide mechanism 150 may be in sliding or gliding contact with a first channel 152 of the base structure 200. As shown in FIG. 3, the first channel 152 may be a “C”-shaped channel with which the first glide mechanism 150 may be in gliding contact. Thus, as the panel 104 is moved in the directions denoted by the arrow 130, the first glide mechanism 150 may glide within the first channel 152.

As discussed in greater detail herein, the first glide mechanism 150 may be sized such that upper portions of the first glide mechanism 150 contact a ceiling of the first channel 152 and that lower portions of the first glide mechanism 150 contact a floor of the first channel 152. The contact between the first glide mechanism 150 and the first channel 152 may impede rotation of the panel 104 about a second axis 144 and a third axis 154. That is, the first glide mechanism 150 and the first channel 152 may impede rotation of the panel 104 as denoted by the arrows 146 and 156, e.g., into and out of the page depicting FIG. 1A and as also depicted in FIG. 2.

According to examples and as shown in FIGS. 1B and 2, the guide system 102 may include a second glide mechanism 160. The second glide mechanism 160 may be similar to the first glide mechanism 150 and may also be fixedly attached to the panel 104 such that the second glide mechanism 150 may move with movement of the panel 104. The second glide mechanism 160 may be in sliding or gliding contact with a second channel 162 of the base structure 200. As shown in FIG. 3, the second channel 162 may be a “C”-shaped channel with which the first glide mechanism 150 may be in gliding contact. Thus, as the panel 104 is moved in the directions denoted by the arrow 130, the first glide mechanism 150 may glide within the first channel 152. In addition or in other examples, the first channel 152 and the second channel 162 may have other cross-sectional shapes, such an “I”-shape, a curved shape, or the like. The first channel 152 and the second channel 162 may additionally or alternatively be formed of multiple components.

As discussed in greater detail herein, the second glide mechanism 160 may be sized such that upper portions of the second glide mechanism 160 contact a ceiling of the second channel 162 and that lower portions of the second glide mechanism 160 contact a floor of the second channel 162. The contact between the second glide mechanism 160 and the second channel 162 may also impede rotation of the panel 104 about the second axis 154. That is, the second glide mechanism 160 may also impede rotation of the panel 104 as denoted by the arrow 156.

As shown in FIG. 3, the base structure 200 may include a first base component 202 and a second base component 204 that may be attached together to form a space into which the panel 104 may be inserted. As shown, the first base component 202 may include the first rack 120 and the second rack 126. In addition, the second base component 202 may include the first channel 152 and the second channel 162.

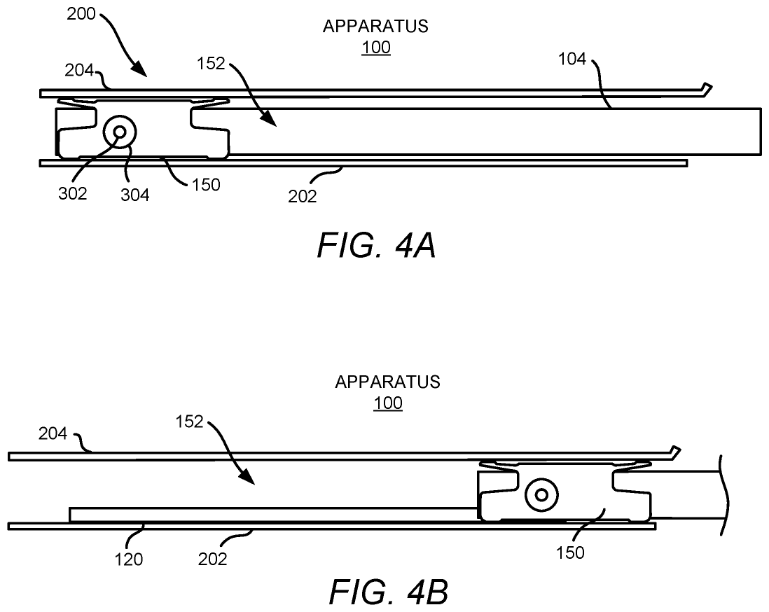

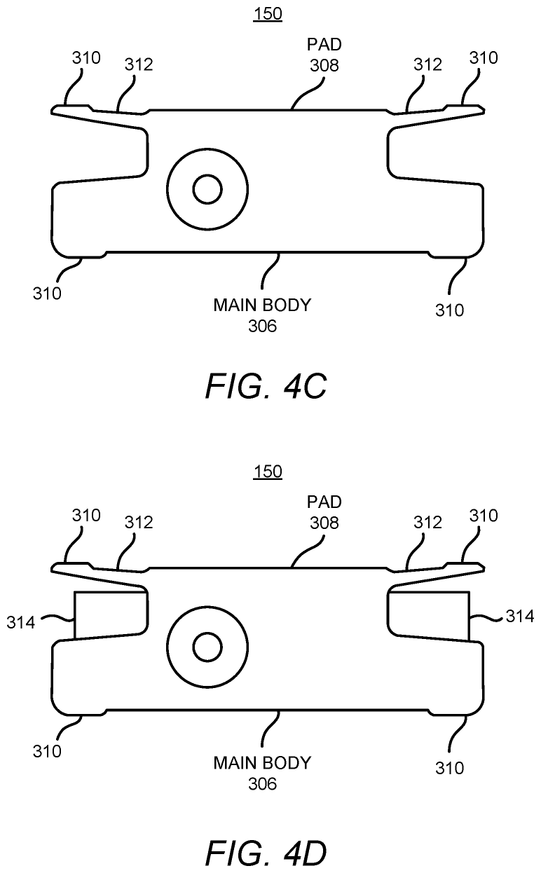

Reference is now made to FIGS. 4A-4D. FIGS. 4A and 4B, respectively, show side views of the example apparatus 100 depicted in FIGS. 1A-2 and a cross-sectional side view of the base structure 200 depicted in FIG. 3. FIGS. 4C and 4D, respectively, show enlarged side views of example first glide mechanisms 150. It should be understood that the apparatus 100 depicted in FIGS. 4A and 4B and/or the first glide mechanisms 150 depicted in FIGS. 4C and 4D may include additional components and that some of the components described herein may be removed and/or modified without departing from the scopes of the apparatus 100 and/or the first glide mechanisms 150 disclosed herein.

FIG. 4A depicts the panel 104 in a first position (e.g., a storage position) with respect to the base structure 200 and FIG. 4B depicts the panel 104 in a second position (e.g., an extend position) with respect to the base structure 200. As shown, the first glide mechanism 150 may glide within the first channel 152 of the base structure 200 as the panel is moved between the first position and the second position. In addition, although not explicitly shown in FIGS. 4A and 4B, the first gear 110 may engage with the first rack 120 such that the first gear 110 rotates as the panel 104 is moved between the first position and the second position.

According to examples, the first glide mechanism 150 may be fixedly attached to the panel 104 via a mechanical fastener 302, which may be a screw, a rivet, or the like. In these examples, the first glide mechanism 150 may include a countersink 304 such that a head of the mechanical fastener 302 may be below an outer surface of the first glide mechanism 150. In other examples, the first glide mechanism 150 may be fixedly attached to the panel 104 in other manners such as through welding, use of an adhesive, friction fitting, and/or the like. In still other examples, the first glide mechanism 150 may be integrally formed with the panel 104, e.g., molded with the panel 104.

As shown in FIGS. 4A-4D, the first glide mechanism 150 may include a shape that has a width that is greater than the height. In addition, the first glide mechanism 150 may include a main body 306 and a pad 308 on a surface of the main body. The first glide mechanism 150 may also include a plurality of contact points 310 positioned on the bottom and the top of the first glide mechanism 150. The contact points 310 may be locations of the first glide mechanism 150 that may glide on surfaces of the first channel 152. The contact points 310 on the top of the first glide mechanism 150 may be positioned on flexible arms 312 that extend from the main body 306.

The flexible arms 312 may have sufficient flexibility to maintain separation between the top of the first channel 152 and the pad 308 when a nominal amount of force is applied to the panel 104. However, when sufficient force to cause the flexible arms 312 to flex is applied to the panel 104, the panel 104 may rotate (e.g., be torqued) as indicated by the arrow 156 about an axis 154 as shown in FIG. 4B. Once the flexible arms 312 have flexed a certain distance, the pad 308 may contact the ceiling of the first channel 152. In the example shown in FIG. 4D, when the flexible arms 312 are flexed beyond a certain distance, the flexible arms 312 may contact overload blocks 314 positioned beneath the flexible arms 312. The overload blocks 314 may be attached to the main body 306 via mechanical fasteners, adhesives, or the like, or may be integral with the main body 306. In other examples, the overload blocks 314 may instead be attached to the flexible arms 312. In one regard, the contact between the pad 308 and the ceiling of the first channel 152 and/or the contact between the flexible arms 312 and the overload blocks 314 may impede or prevent the panel 105 from rotating further. The relatively small movement of the panel 104 allowed about the axis 154 (as may be represented by the arrow 156 shown in FIG. 2) may, however, provide a certain ergonomic feel.

Although not shown, the second glide mechanism 160 may have a similar configuration to the first glide mechanism 150. The second glide mechanism 160 may also function similarly to the first glide mechanism 150. The second glide mechanism 160 may thus be attached to the panel 104 in any of the manners discussed herein with respect to the first glide mechanism 150.

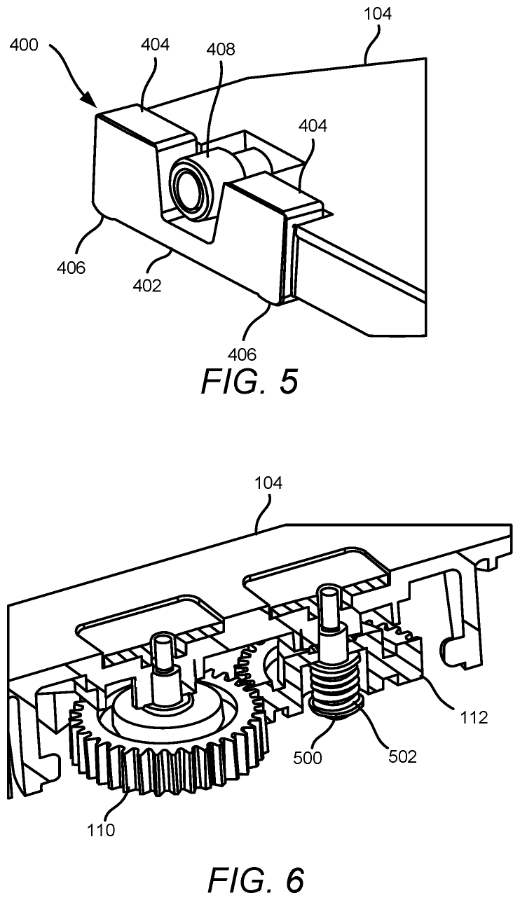

Turning now to FIG. 5, there is shown a perspective view of an example glide mechanism 400 that may have a different configuration from the first glide mechanism 150 depicted in FIGS. 4A-4C. It should be understood that the example glide mechanism 400 depicted in FIG. 5 may include additional components and that some of the components described herein may be removed and/or modified without departing from the scope of the example glide mechanism 400 disclosed herein.

As shown, the glide mechanism 400 may include a main body 402 and pads 404, in which the main body may be attached to the panel 104 in any suitable manner, e.g., through a mechanical fastener, through an adhesive, through friction fitting, and/or the like. The glide mechanism 400 may also include contact points 406 that are to contact a floor of the first channel 220. The glide mechanism 400 may further include a roller 408 that may contact a ceiling of the first channel 220. The roller 408 and the contact points 406 may maintain separation between the pads 404 and the ceiling of the first channel 220 under application of normal stresses on the panel 104. However, when sufficient force is applied to the panel 104 to be torqued in the direction denoted by the arrow 156, one or both of the pads 404 may contact the ceiling of the first channel 220 to impede or prevent further rotation of the panel 104. Alternatively, additional rollers may be provided at the contact point 406. The additional rollers may be similar to the roller 408, such that the glide mechanism 400 may have a three roller guide configuration.

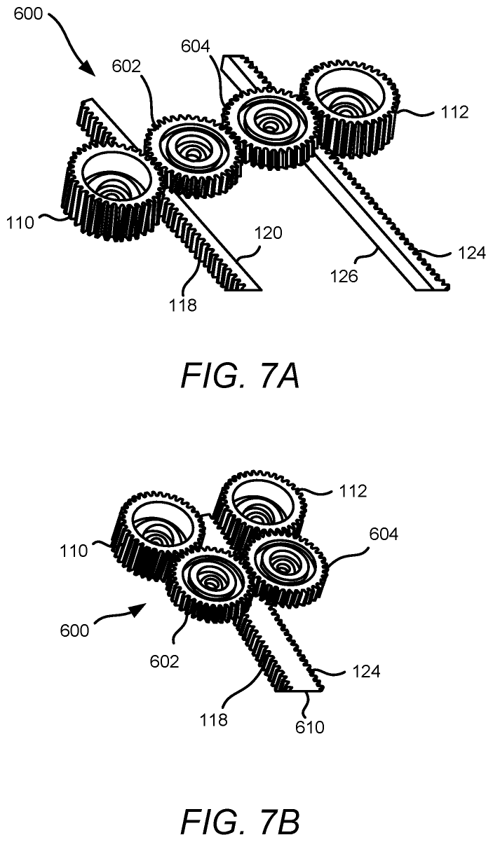

Turning now to FIG. 6, there is shown a perspective view, partially in cross section, of an example first gear 110 and an example second gear 112 that may include a dampening mechanism 500. Generally speaking, the first gear 110 and the second gear 112 shown in FIGS. 1A-2 may include the dampening mechanism 500. In any regard, the dampening mechanism 500 in the first gear 110 may dampen or impede rotation of the first gear 110 and the dampening mechanism 500 in the second gear 112 may dampen or impede rotation of the second gear 112. As shown, the dampening mechanism 500 may include a spring 502 and thus, the level of dampening applied onto the first gear 110 or the second gear 112 may be varied through varying the spring rate of the spring 502. In some examples, the dampening mechanism 502 may be provided in the gears 110 and 112 to provide an increased resistance to the movement of the panel 104. As a result, movement of the panel 104 may appear to have a heavier and more solid feel.

Turning now to FIGS. 7A-7D, there are respectively shown example gear arrangements that may be employed in the guide systems 102 in place of the gears 110, 112 and the racks 120, 126 depicted in FIGS. 1A-2. As shown in FIG. 7A, the teeth 118, 124 of the first rack 120 and the second rack 126 may face opposite directions with respect to each other. In addition, the first gear 110 may be positioned between an edge of the panel 104 and the first rack 120 instead of being positioned between the first rack 120 and the second rack 126. Likewise, the second gear 112 may be positioned between an opposite edge of the panel 104 and the second rack 126. Moreover, a connecting mechanism 600 may functionally connect the first gear 110 to the second gear 112, in which the connecting mechanism 600 may cause the first gear 110 and the second gear 112 to rotate in concert (or equivalently, in unison) with respect to each other. As shown in FIG. 7A, the connecting mechanism 600 may include a first intermediate gear 602 and a second intermediate gear 604 that are meshed together and respectively to the first gear 110 and the second gear 112. The first intermediate gear 602 and the second intermediate gear 604 may both be rotatably attached to the panel 104.

Turning now to FIG. 7B, instead of two separate racks 120, 126, a single rack 610 may be provided, in which the single rack 610 may include teeth 118, 124 to engage the first gear 110 and the second gear 112 on opposite sides of the rack 610. In addition, the first intermediate gear 602 and the second intermediate gear 604 may be positioned to cause the first gear 110 and the second gear 112 to rotate in unison with respect to each other.

In the example shown in FIG. 7C, a set of additional gears 612, 614 may be positioned between the first rack 120 and the second rack 124. In the example shown in FIG. 7D, the connecting mechanism 620 may be a belt 620 that may include teeth 622 to mesh with the teeth on the first gear 110 and the second gear 112. As a result, when the first gear 110 rotates, the second gear 112 may be caused to rotate through rotation of the belt 620. In further examples, instead of or in addition to the belt 620, the connecting mechanism 620 may include a drive shaft that may be positioned and connected to the first and second gears 110, 112 to cause the gears 110, 112 to rotate in concert with each other.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure. For instance, it should be understood that any or each of the gears 110, 112, 602, 604, 612, 614 may include the dampening mechanism 500 depicted in FIG. 6. Additionally, or alternatively, although the guide system 102 has been described as being attached to the panel 104, in other examples, components of the guide system 102 may instead be attached to the base structure 200. In these examples, for instance, the first rack 120 and the second rack 126 may be attached to the panel 104. Moreover, the glide mechanisms 150, 160 may be attached to either of the base structure 200 or the panel 104.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a guide system including:
a first gear having teeth to engage with a first set of teeth;
a second gear having teeth to engage with a second set of teeth, the first gear and the second gear to rotate in concert with respect to each other; and
a first glide mechanism to slidably contact a first channel; and
a panel to employ the guide system to be slidably mounted to a base structure, wherein the first gear and the second gear are to impede rotation of the panel about a first axis and the first glide mechanism is to impede rotation of the panel about a second axis.

2. The apparatus of claim 1, further comprising:
a second glide mechanism to slidably contact a second channel, wherein the first gear and the second gear are rotatably attached to the panel, wherein the first glide mechanism and the second glide mechanism are attached to the panel, wherein the base structure includes the first channel and the second channel, and wherein the first rack and the second rack are attached to the base structure.

3. The apparatus of claim 1, further comprising:
a second glide mechanism to slidably contact a second channel, wherein the first glide mechanism is positioned at a first edge of the panel, the second glide mechanism is positioned at a second edge of the panel, and the first gear and the second gear are positioned between the first edge of the panel and the second edge of the panel.

4. The apparatus of claim 1, wherein the first gear and the second gear are positioned near a first edge of the panel and wherein the first glide mechanism is positioned between the first edge of the panel and a second edge of the panel.

5. The apparatus of claim 1, wherein the first glide mechanism comprises a main body, a pad on a surface of the main body, and flexible arms extending from the main body, the main body and the flexible arms including contact points, wherein the contact points are to contact the first channel, and wherein the pad is to contact a wall of the first channel when the panel is pushed in a certain direction beyond a certain distance.

6. The apparatus of claim 1, a connecting mechanism that connects the first gear to the second gear, the connecting mechanism to cause the first gear and the second gear to rotate in concert with respect to each other, and the connecting mechanism comprises an additional gear, a belt, a drive shaft or a combination thereof.

7. The apparatus of claim 1, wherein the first gear, the second gear, or both, comprises a dampening mechanism to impede movement of the panel.

8. The apparatus of claim 1, wherein the first gear and the second gear are rotatably attached to the base structure, wherein the first glide mechanism is attached to the base structure, and wherein the panel includes the first set of teeth, the second set of teeth, and the first channel.

9. A system comprising:
a base structure having a first rack, a second rack, and a first channel;
a panel slidably insertable into the base structure, the panel including:
a first gear having teeth to mesh with teeth on the first rack, the first gear being rotatably attached to the panel;
a second gear having teeth to mesh with teeth on the second rack, the second gear being rotatably attached to the panel, wherein the first gear and the second gear are functionally connected to each other to cause the first gear and the second gear to rotate in unison with respect to each other as the panel is moved with respect to the base structure; and
a first glide mechanism to contact a wall of the first channel.

10. The system of claim 9, wherein a meshing of the first gear with the first rack and a meshing of the second gear with the second rack is to prevent rotation of the panel about a first axis with respect to the base structure and a gliding engagement of the first glide mechanism to the wall of the first channel is to prevent rotation of the panel about a second axis with respect to the base structure.

11. The system of claim 9, wherein the base structure further comprises a second channel, and wherein the panel further includes a second glide mechanism to contact a wall of the second channel.

12. The system of claim 11, wherein the base structure includes a first edge and a second edge located opposite to the first edge, wherein the first channel is positioned at the first edge and the second channel is positioned at the second edge, and wherein the first rack and the second rack are positioned between the first edge and the second edge.

13. The system of claim 9, further comprising:
a connecting mechanism to functionally connect the first gear to the second gear, the connecting mechanism causing the first gear and the second gear to rotate in unison with respect to each other.

14. A system comprising:
a base structure having:
a first rack having teeth;
a second rack having teeth;
a first channel; and
a second channel; and
a panel including:
a first gear having teeth meshed with the teeth of the first rack;
a second gear having teeth meshed with the teeth of the second rack, the first gear and the second gear being functionally connected to each other to cause the first gear and the second gear to rotate in unison with respect to each other as the panel is moved with respect to the base structure;
a first glide mechanism to contact a surface in the first channel; and
a second glide mechanism to contact a surface in the second channel.

15. The system of claim 14, wherein each of the first glide mechanism and the second glide mechanism comprises a main body, a pad on a surface of the main body, and flexible arms extending from the main body, the main body and the flexible arms including contact points.
